(19) United States
(12) Patent Application Publication
(10) Pub. No.: US 2010/0058628 A1
(43) Pub. Date: Mar. 11, 2010

(54) Frame Assembly for Displaying Indicia and Reflecting An Image

(75) Inventors: Brian P. Reid, Mooresville, NC (US); Walter J. Gierlach, III, Poland, OH (US); Daniel Pompei Cedrone, Huntersville, NC (US)

Correspondence Address: SUMMA, ADDITON & ASHE, P.A., 11610 NORTH COMMUNITY HOUSE ROAD, SUITE 200, CHARLOTTE, NC, 28277, US

(73) Assignees: Brian P. Reid, Mooresville, NC (US); Walter J. Gierlach, Poland, OH (US)

(21) Appl. No.: 12/555,331

(22) Filed: Sep. 8, 2009

Related U.S. Application Data
(60) Provisional application No. 61/094,538, filed on Sep. 5, 2008.

(51) Int. Cl. G09F 13/12

(52) U.S. Cl. 40/219

(57) ABSTRACT

The invention relates to a frame assembly for displaying a plurality of indicia and reflecting an image. The frame assembly comprises a frame supporting at least one light source, a sheet member positioned adjacent to the light source, a substrate bearing indicia releasably secured to the sheet member, a mirror positioned adjacent to the sheet member and light source, and a sensor for detecting an object. The frame assembly in a first mode displays desired indicia through the mirror and, upon the sensor detecting an object at a desired distance, in a second mode functions as a mirror to reflect an image.

### CROSS-REFERENCE TO PRIORITY APPLICATIONS

This application claims the benefit of and priority to U.S. Provisional Patent Application Ser. No. 61/094,538, filed Sep. 5, 2008, in the U.S. Patent and Trademark Office. This application incorporates the provisional applications by reference in their entirety.

### BACKGROUND OF THE INVENTION

The invention relates to a frame assembly for displaying a plurality of indicia and reflecting an image, and more specifically, to a frame assembly having a frame supporting at least one light source, a sheet member bearing indicia positioned adjacent to the light source, a film or substrate bearing the indicia and releasably secured to the sheet member, a mirror positioned adjacent to the sheet member and light source, and a sensor, wherein the frame assembly in a first mode displays desired indicia through the mirror and in a second mode functions as a mirror to reflect an image. As configured, the first mode permits the light source to project light through the sheet member and mirror thereby displaying the indicia on the sheet member via backlighting. In a second mode, the sensor detects the presence of an object or individual in front of the frame assembly and deactivates the light source thereby permitting the mirror to serve a conventional purpose (i.e., reflecting an image of an object in front of the mirror).

The presence of mirrors in multiple locations (e.g., washrooms, dressing rooms, hotel rooms, etc.) provides an ideal opportunity to display any number of public service announcements, advertisements, or news stories. In conventional uses, mirrors serve a reflecting purpose. In other words, individuals use mirrors during washing, grooming, shopping, and dressing. In locations where announcements or advertisements are co-located with mirrors (e.g., restaurant bathrooms), the announcements and mirrors require separate wall space. As a result, wall space becomes cluttered and unattractive when bearing mirrors, flyers, advertisements, and various listings.

### SUMMARY OF THE INVENTION

The frame assembly displays any number of indicia in a first mode and reflects an image in a second mode. The frame assembly comprises in one embodiment a frame, at least one light source supported by the frame, a sheet member supported by the frame, a substrate bearing indicia releasably secured to the sheet member, a mirror supported by the frame, and a sensor supported by the frame. The frame may be positioned on a wall, shelf, or any suitable surface. The light source may be secured within or on the frame. The light source of the frame assembly may be powered by an external power source, a battery, or any variety of power cells. The sheet member is removably secured to the frame adjacent to the light source. The mirror is removably secured to the frame adjacent to the sheet member and light source. The sensor is secured to the frame in such a manner as to permit the beam or signal emanating from the sensor to pass through openings in the sheet member and mirror, and optionally the substrate.

Advantageously, the inventive frame assembly combines the functions of displaying indicia such as advertisements or announcements, and reflecting an image of, for example, an individual. Further, the frame assembly provides a means to display a plurality of indicia in a single location. Moreover, the invention facilitates the replacement of indicia in an efficient manner.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is an exploded perspective view of one embodiment of the frame assembly of the invention;

FIG. 2A is a perspective view of one embodiment of the frame assembly of FIG. 1 depicting the frame assembly in a first or display mode at distance x;

FIG. 2B is a perspective view of one embodiment of the frame assembly of FIG. 1 depicting the frame assembly in a second or mirror mode at distance y;

FIG. 3 is a partial enlarged perspective view of one embodiment of the frame assembly of FIG. 1 depicting the sensor and light emitting diodes (LEDs); and

FIG. 4 is an exploded view of another embodiment of the frame assembly; and

FIG. 5. is a perspective view of one embodiment of the frame assembly of FIG. 4.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

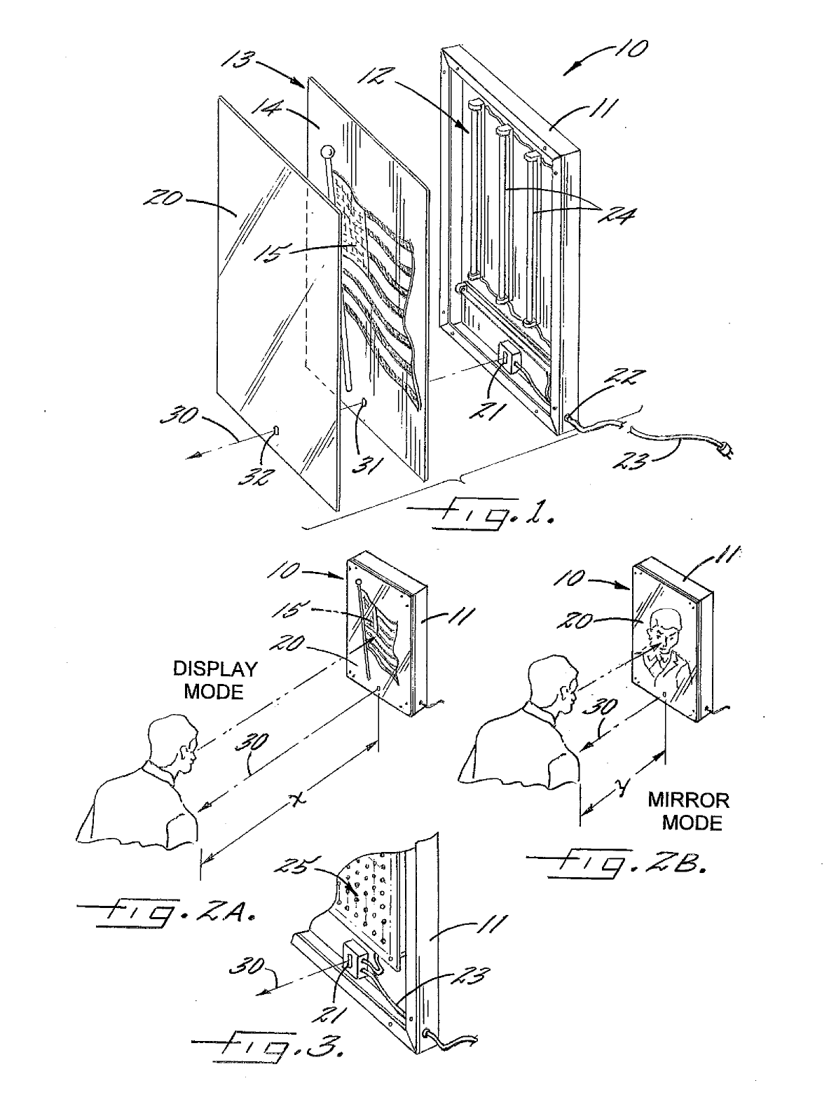

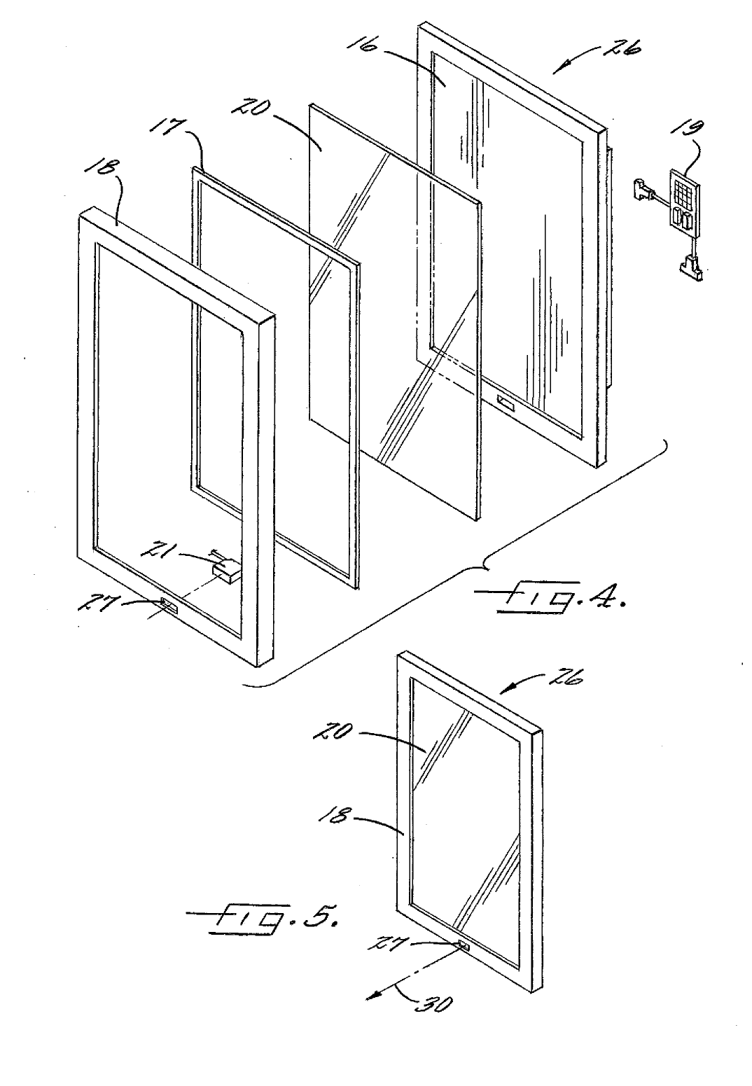

An overall view of an embodiment of a frame assembly of the invention is set forth at 10 in the perspective view of FIG. 1. The frame assembly 10 for displaying a plurality of indicia 15 (e.g., a flag) and reflecting an image (e.g., individual) comprises in one embodiment a frame 11, at least one light source 12 supported by the frame, a sheet member 13 bearing indicia and supported by the frame when positioned substantially adjacent to the light source, a substrate 14 bearing the indicia and releasably secured to the sheet member, a mirror 20 supported by the frame when positioned substantially adjacent to the sheet member and the light source, and a sensor 21 supported by the frame. As configured, the frame assembly 10 functions to display the indicia 15 through the mirror 20 in a first mode of operation (i.e., display mode) and functions as a mirror in a second mode of operation (i.e., mirror mode).

The invention provides a frame 11 for housing and supporting remaining elements of the frame assembly 10. The frame 11 may provide an opening 22 to permit an electrical cord 23 to travel from the light source 12 to a power outlet. In this embodiment, the light source 12 is powered by electricity provided by an external source. Alternatively, the light source may be powered by a battery or power cell and thus, no opening for the power cord is required.

The light source 12 may include any number of light bulbs 24 or light emitting devices (LEDs) 25. For example, the light source 12 may include one or more fluorescent lights or bulbs, one or more light emitting diodes (LEDs), one or more halogen lights, or one or more xenon lights. In one embodiment, the light source 12 may be one or more fluorescent bulbs 24 of sufficient strength to project light through the mirror. In the embodiment relying upon fluorescent bulbs 24 to provide backlighting, the bulbs are individually replaceable for ease of replacement.

In another embodiment, the light source 12 may include a plurality of light emitting diodes (LEDs) 25 of sufficient strength to project light through the sheet member 13, substrate 14 bearing the indicia 15, and the mirror 20. In this embodiment, LEDs 25 provide backlighting and illumination of the indicia 15 on the substrate 14 supported by the sheet member 13. In one embodiment, the LEDs 25 are manipulated on-site to change the indicia 15 or, more advantageously, could be operated remotely via a land line or wireless network.

In an alternative embodiment, the light source 12 may be a plurality of LEDs 25 arranged in a specific pattern and capable of depicting desired indicia. This embodiment lacks a sheet member 13 or substrate 14 bearing indicia 15. In yet another embodiment, a plurality of independently activated LEDs 25 may be relied upon to depict any number of desired indicia.

The sheet member 13 is transparent and may bear any number of reusable and removable substrates 14 carrying indicia 15. In one embodiment the sheet member 13 is releasably secured to the frame 11 substantially adjacent to the light source 12. The sheet member 13 may be secured to the frame 11 with any number of releasable fasteners or adhesives. The sheet member 13 may be formed from any number of materials capable of providing transparency. For example, the sheet member 13 may be formed from acrylic that is extruded as a sheet, or a polycarbonate resin thermoplastic.

The sheet member 13 supports the reusable, removable substrate 14 bearing indicia. Accordingly, the substrate 14 may be removed and replaced with any number of substrates bearing any number of indicia 15. The substrate 14 is of sufficient transparency to permit light from the light source 12 to pass there through and illuminate indicia on the substrate.

The mirror 20 reflects an image and is removably secured to the frame 11. In one embodiment the mirror 20 is removably secured to the sheet member 13 and frame 11. The mirror 20 is reflective on one side and transparent on another side. For example, the mirror 20 may be a security mirror of the type used for surveillance of an area. The mirror 20 is secured to the frame 11 substantially adjacent to the sheet member 13. The mirror 20 may be secured to the frame 11 and sheet member 13 with any number of releasable fasteners or adhesives.

In one embodiment, the mirror 20 includes one side painted with reflective material that permits light from the light source 12 approaching from an opposite side to pass through the mirror. In another embodiment, the mirror 20 includes a laminated reflective film adhered to one side that permits light approaching from an opposite side to pass through the mirror.

The sensor 21 is supported by the frame 11 and is adjustable such that it detects the presence of an object at any number of desired distances x, y. The sensor 21 communicates with the light source 12 to activate and deactivate the light source, and alternate between the first and second modes of the assembly. The sensor 21 projects a signal or beam 30 to detect the presence of an object. Upon sensing an object (e.g., individual), the sensor 21 interrupts power to the light source 12, and the mirror 20 reflects an image of, for example, the individual standing in front of the mirror. The sensor 21 is adjustable to detect objects within, for example, one to four feet in its vicinity. For example, as shown in FIG. 2A illustrating the first or display mode, the signal 30 of the sensor 21 is adjusted such that its range for detecting an object is beyond distance x, and the invention displays the indicia 15 via backlighting provided by the light source. As shown in FIG. 2B illustrating the second or mirror mode, the signal 30 identifies an object at distance y, interrupts power to the light source 12, and permits an individual to use the mirror.

The sheet member 13 and the mirror 20 each define at least one opening 31, 32, respectively, through which the signal 30 from the sensor 21 travels. The substrate 14 may also define at least one opening 33 if required. Stated differently, openings 31, 32 are provided in the sheet member 13 and mirror 20 to permit passage of the signal 30 from the sensor 21 in the frame 11, through the sheet member 13, substrate 14 and mirror 20, and into the space adjacent to the frame assembly. Alternatively, sufficient transparency is provided in at least a portion of the sheet member 13 and mirror 20 to permit passage of the signal 30 from the sensor 21 into the space adjacent to the frame assembly 10.

In yet another embodiment depicted in FIGS. 4 and 5, a frame assembly 26 for displaying indicia and reflecting an image comprises a frame 18 defining an opening 27, a display panel 16 (e.g., liquid crystal display (LCD) monitor) supported by the frame 18, a mirror 20 positioned substantially adjacent to the LCD monitor 16, an adhesive sheet 17 having adhesive on both sides (e.g., two-sided tape) for securing the mirror to the frame 18, an interrupt circuit board 19 for operating the frame assembly 26, and a sensor 21 supported by the frame or monitor. This embodiment lacks a sheet member or substrate. The sensor 21 and interrupt circuit board 19 operate to interrupt power to the monitor upon detection of an object at a desired distance. Advantageously, the monitor 16 is capable of displaying any variety of indicia and may be operated remotely.

In particular, this alternative embodiment would permit an individual to remotely change the indicia appearing in the frame assembly for any number of reasons. For example, an individual could alternate images or advertisements depending upon the time of day, weather, or expected crowd. Further, if collecting a fee for providing the advertising space, the individual could remotely remove an advertisement from an individual who did not pay or power off the frame assembly if, for example, a restaurant owner was leasing the frame assembly and failed to pay.

In yet another embodiment, the frame assembly 10 may include a monitor 16 having a reflective screen, eliminating the need for a mirror 20, sheet member 13, and substrate 14.

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A frame assembly for displaying indicia and reflecting an image, said frame assembly comprising:
a frame;
at least one light source supported by said frame;
a sheet member supported by the frame and positioned substantially adjacent to said at least one light source, said sheet member bearing indicia;
a mirror supported by the frame and positioned substantially adjacent to said sheet member and said at least one light source, said mirror for reflecting an image; and
a sensor supported by said frame, said sensor for detecting the presence of an object at a desired distance;
wherein said frame assembly in a first mode of operation functions to display said indicia through said mirror; and
wherein said frame assembly in a second mode functions as a mirror.

2. The frame assembly of claim 1 wherein said at least one light source is selected from the group consisting of at least one florescent light, at least one light emitting diode (LED), at least one halogen light, and at least one xenon light.

3. The frame assembly of claim 1 wherein said sheet member is transparent.

4. The frame assembly of claim 1 wherein said sheet member is removably secured to said frame.

5. The frame assembly of claim 1 wherein said mirror is removably secured to said frame.

6. The frame assembly of claim 1 wherein said mirror is removably secured to said sheet member and said frame.

7. The frame assembly of claim 1 wherein said mirror is reflective on one side and transparent on another side.

8. The frame assembly of claim 1 wherein said sensor is adjustable such that it detects an object at a plurality of desired distances.

9. The frame assembly of claim 1 wherein said sensor communicates with said at least one light source to activate and deactivate said light source.

10. The frame assembly of claim 1 wherein said sheet member and said mirror define an opening through which a signal from the sensor travels.

11. The frame assembly of claim 1 further comprising a reusable, removable substrate bearing said indicia, said substrate of sufficient transparency to permit light from said light source to pass through said substrate and illuminate said indicia on the substrate.

12. A frame assembly for displaying indicia and reflecting an image, said frame assembly comprising:
a frame;
a display panel supported by said frame, said display panel capable of displaying a plurality of indicia;
a mirror supported by said frame and positioned substantially adjacent to said display panel, said mirror for reflecting an image; and
a sensor supported by said frame, said sensor for detecting the presence of an object at a desired distance;
wherein said frame assembly in a first mode of operation functions to display said indicia through said mirror; and
wherein said frame assembly in a second mode functions as a mirror.

13. The assembly of claim 12 wherein said display panel is operated remotely.

14. The assembly of claim 12 wherein said frame defines an opening through which a signal from said sensor travels.

15. The assembly of claim 12 wherein said mirror is a two-way mirror.

16. The assembly of claim 12 further comprising an adhesive sheet positioned between said frame and said mirror for securing said mirror to said frame.

17. The assembly of claim 12 further comprising an interrupt circuit board secured to said display panel in communication with said sensor for switching said assembly between the first mode and the second mode.
